(19) United States
(12) Patent Application Publication
(10) Pub. No.: US 2009/0295759 A1
(43) Pub. Date: Dec. 3, 2009

(54) WIRELESS TOUCH SCREEN PEN

(75) Inventor: Fredrik Thorsell, Stockholm (SE)

Correspondence Address: WARREN A. SKLAR (SOER);RENNER, OTTO, BOISSELLE & SKLAR, LLP, 1621 EUCLID AVENUE, 19TH FLOOR, CLEVELAND, OH, 44115, US

(73) Assignee: SONY ERICSSON MOBILE COMMUNICATIONS AB, Lund (SE)

(21) Appl. No.: 12/129,248

(22) Filed: May 29, 2008

(51) Int. Cl. G06F 3/033

(52) U.S. Cl. 345/179

(57) ABSTRACT

A method and apparatus for producing a signal in a pen is disclosed. When at least one section of the pen is deformed, a hammer device strikes a piezo-electronic component. In response to being struck by the hammer device, the piezo-electric component generates an electric signal. The electric signal is then applied to a wire wound inductor to create an electromagnetic nearfield.

### TECHNICAL FIELD OF THE INVENTION

The present invention relates to a wireless touch screen pen and more particularly to a wireless touch screen pen for communicating with a PDA or touch screen using electromagnetic nearfield coupling.

### DESCRIPTION OF RELATED ART

When using a touch screen on a small device the most common approach is to use a device similar to a pen to be able to accurately manage to press a small softkey, scrollbar, etc. Recently, the Apple I-phone® has brought another approach to the market using gestures on the touch screen to add another degree of freedom to touch screen control using fingers. The downside of this is that one of the more important features of touch screen devices, such as character recognition writing, is best done with a pen like accessory. Most GUIs for modern computers are controlled by a mouse that depending on the vendor, has a number of buttons with separate function. In Windows® operating systems, a minimum of 2 buttons, in Apple® systems 1 button and in Unix/Linux 3 button mouse. The point is that the user of a touch screen device with a graphic user interface is very used to having more possibilities than a simple tap with a pen.

Thus, there is a need for a wireless touch screen pen which is capable of generating at least one “click” apart from the tap of the pen on the touch screen of a device so as to increase the functionality of a touch screen pen.

### SUMMARY OF THE INVENTION

According to some embodiments of the invention, a method for producing a signal in a pen comprising the steps of: deforming at least one section of the pen wherein a hammer device strikes a piezo-electronic component when the pen is deformed; generating an electric signal in the piezo-electric component; applying the electric signal to a wire wound inductor to create an electromagnetic nearfield.

According to another embodiment of the invention, a wireless touch screen pen, comprising; a piezo-electric component; a hammer device for striking the piezo-electric component when part of the pen is deformed, wherein said piezo-electric component generates an electric signal when struck by the hammer device; means for producing an electromagnetic nearfield when the electronic signal is applied to the means.

Further embodiments of the invention are defined in the dependent claims.

It is an advantage of embodiments of the invention that a user has several ways of communicating with a touch screen device using electromagnetic nearfield coupling.

### BRIEF DESCRIPTION OF THE DRAWINGS

Further objects, features and advantages of embodiments of the invention will appear from the following detailed description of the invention, reference being made to the accompanying drawings, in which:

FIGS. 1(a)-(b) illustrate a wireless touch screen pen according to one embodiment of the invention;

FIG. 2 is a flow chart describing the operation of the pen according to one embodiment of the invention; and

FIGS. 3(a)-(b) illustrate a wireless touch screen pen according to one embodiment of the invention;

FIGS. 4(a)-(b) illustrate a wireless touch screen pen according to one embodiment of the invention; and

FIG. 5 illustrates a wireless touch screen pen and a touch screen device according to one embodiment of the invention.

### DETAILED DESCRIPTION OF EMBODIMENTS

Specific illustrative embodiments of the invention will now be described with reference to the accompanying drawings. This invention may, however, be embodied in many different forms and should not be construed as limited to the embodiments set forth herein. Rather, the disclosed embodiments are provided so that this specification will be thorough and complete, and will fully convey the scope of the invention to those skilled in the art. The terminology used in the detailed description of the particular embodiments illustrated in the accompanying drawings is not intended to be limiting of the invention. Furthermore, in the drawings like numbers refer to like elements.

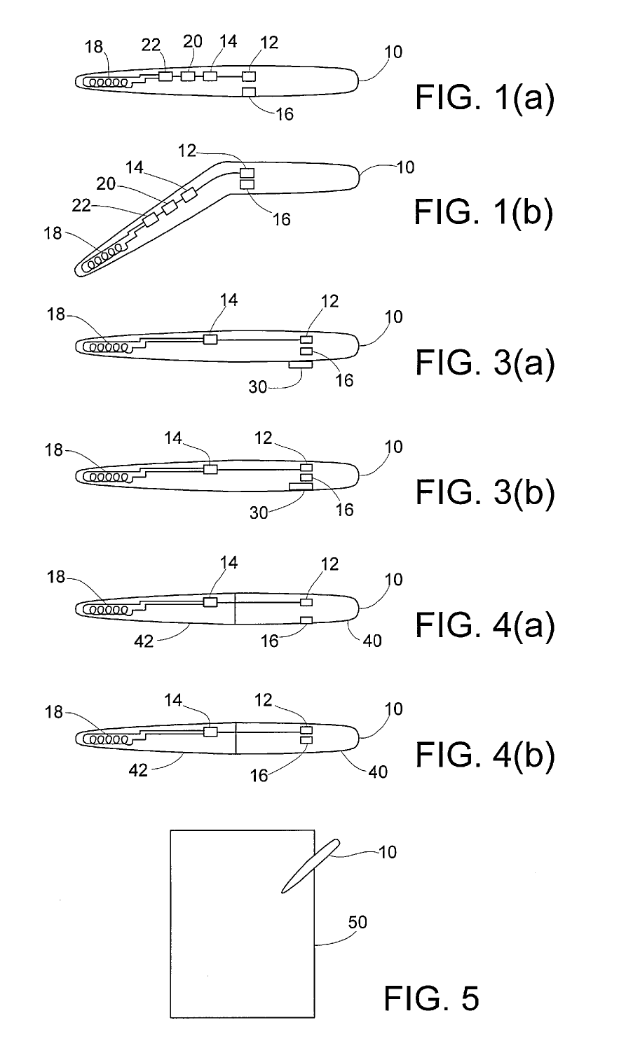

FIGS. 1(a)-(b) illustrate a wireless touch screen pen 10 according to one embodiment of the invention. The touch screen pen 10 comprises a piezo-electric component 12, a up-converter 14, a hammer device 16, a modulator 20, a filter 22 and a device for producing an electromagnetic nearfield 18. The piezo-electric component 12 can be a piezo ceramic or a quatrz component and the invention is not limited thereto. The device 18 for producing an electromagnetic nearfield can be a wire coil located at one end of the pen 10 and the invention is not limited thereto.

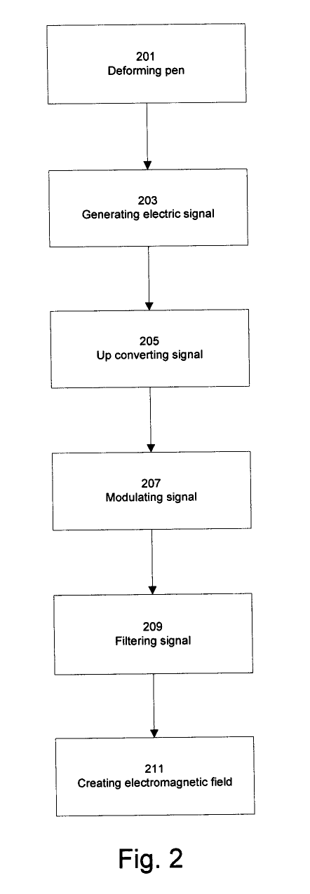

The operation of the touch screen pen 10 will now be described with reference to FIG. 2. The piezo-electric component 12 is capable of turning a mechanical deformation into an electric potential or an electric signal. According to one embodiment of the invention, the touch screen pen 10 is deformed in a manner that causes the hammer device 16 to strike the piezo-electric component 12 in step 201. The touch screen pen 10 can be deformed in several ways and the invention is not limited thereto. First the touch screen pen 10 may be bent, as illustrated in FIGS. 1(a)-(b), to a point where the spring tension on the hammer device 16 is released causing the hammer device 16 to strike the piezo-electric component 12. Alternatively, the touch screen pen 10 may have a button 30 which when pressed by the user causes the tension on the hammer device 16 to be released resulting in the hammer device 16 striking the piezo-electric component 12 as illustrated in FIGS. 3(a)-(b). Alternatively, the touch screen pen 10 may be divided into two sections 40 and 42 which can twist relative to each other. Thus, when the user twists one section of the pen, the tension on the hammer device 16 is released and the hammer device strikes the piezo-electric component 12 as illustrated in FIGS. 4(a)-(b). It will be understood that the touch screen pen 10 may comprise more than one means for deforming the pen and the invention is not limited thereto. Furthermore, different resonance frequencies and/or modulation for two or more buttons, etc., on the same device makes it possible for the touch screen device to distinguish clicks from different, in this case, buttons.

Returning to FIG. 3, when the hammer device 16 strikes the piezo-electric component 12, the piezo-electric component 12 generates an electric signal in step 203. Optionally, the electric signal is sent to the up-converter 14. The up-converter 14 converts the electric signal to a suitable frequency band for example using a passive semiconductor or other materials with non-linear characteristics, e.g. various metal oxides, in step 205. Optionally, the up-converted signal may be moduated by a modulator 20 and/or filtered by a filter 22 in steps 207 and 209 respectively.

The processed signal or the original electric signal is then applied to the wire wound inductor 18 in the tip of the pen. When the processed signal is applied to the wire wound inductor 18, a strong electromagnetic field is created at the tip of the pen 10 in step 211. When the strong electromagnetic field is created, the electromagnetic field can be sensed by a touch screen device 50 in a variety of ways if the tip of the touch screen pen 10 is close to the touch screen device 50 as illustrated in FIG. 5. For example, the electromagnetic field can be detected at signal lines in the printed circuit board of the touch screen device 50 intended for other signals or in printed circuit board loops, inductors or other components dedicated for detecting the presence of the electromagnetic field. For example, a small RF detector on or off the printed circuit board can be used to recognize the detected signal and produce a basband signal indicating that a pen event (click) has occured. Already present RF processing circuit or a touch screen device could also be used for this purpose. A single or a set of unique frequencies and/or modulation for a single device will prevent devices which are close to each other from interfering with each other. Finally, the coupling to the touch screen device 50 could also be accomplished through, e.g. capacitive coupling using the strong electric fields at a sharp metallic point fed a high voltage or other similar methods.

The present invention has been described above with reference to specific embodiments. However, other embodiments than the above described are equally possible within the scope of the invention. Different method steps than those described above, performing the method by hardware or software or a combination of hardware and software, may be provided within the scope of the invention. It should be appreciated that the different features and steps of the invention may be combined in other combinations than those described. The scope of the invention is only limited by the appended patent claims.

What is claimed is:

1. A wireless touch screen pen, comprising:
a piezo-electric component;
a hammer device for striking the piezo-electric component when part of the pen is deformed, wherein said piezo-electric component generates an electric signal when struck by the hammer device;
means for producing an electromagnetic nearfield when the electronic signal is applied to the means.

2. The wireless touch screen pen according to claim 1, wherein the means for producing the electromagnetic nearfield is located near a tip of the pen.

3. The wireless touch screen pen according to claim 1, wherein the means for producing the electromagnetic nearfield is a wire wound inductor.

4. The wireless touch screen pen according to claim 1, further comprising:
an up converter for converting the electronic signal to a suitable band.

5. The wireless touch screen pen according to claim 4, further comprising:
a modulation unit for modulating the up converted electric signal;
a filter for filtering the modulated electric signal prior to the signal being applied to the means for producing the electromagnetic nearfield.

6. The wireless touch screen pen according to claim 1, wherein the pen is deformed when a button on the pen is depressed.

7. The wireless touch screen pen according to claim 1, wherein the pen is deformed when the pen is bent to a point where built up tension on the hammer device is released and the hammer strikes the piezo-electric component.

8. The wireless touch screen pen according to claim 1, wherein the pen is deformed by twisting part of the pen relative to the rest of the pen.

9. The wireless touch screen pen according to claim 1, wherein the pen comprises multiple piezo-electric component and multiple hammer devices wherein the electric signals produced by each piezo-electric component are processed in different ways so that the signals are distinguishable.

10. The wireless touch screen pen according to claim 4, wherein the up-converter is a passive semiconductor.

11. The wireless touch screen pen according to claim 4, wherein the up-converter has non-linear characteristics.

12. A method for producing a signal in a pen comprising the steps of:
deforming at least one section of the pen wherein a hammer device strikes a piezo-electronic component when the pen is deformed;
generating an electric signal in the piezo-electric component;
applying the electric signal to a wire wound inductor to create an electromagnetic nearfield.

13. The method according to claim 12, wherein the means for producing the electromagnetic nearfield is located near a tip of the pen.

14. The method according to claim 12, wherein the means for producing the electromagnetic nearfield is a wire wound inductor.

15. The method according to claim 12, further comprising the step of:
up-converting the electric signal to a suitable band.

16. The method according to claim 15, further comprising the steps of:
modulating the up converted electric signal;
filtering the modulated electric signal prior to the signal being applied to the means for producing the electromagnetic nearfield.

17. The method according to claim 12, wherein the pen is deformed when a button on the pen is depressed.

18. The method according to claim 12, wherein the pen is deformed when the pen is bent to a point where built up tension on the hammer device is released and the hammer strikes the piezo-electric component.

19. The method according to claim 12, wherein the pen is deformed by twisting part of the pen relative to the rest of the pen.

20. The method according to claim 12, wherein the pen comprises multiple piezo-electric component and multiple hammer devices wherein the electric signals produced by each piezo-electric component are processed in different ways so that the signals are distinguishable.

21. The method according to claim 15, wherein the up-converter is a passive semiconductor.

22. The method according to claim 15, wherein the up-converter has non-linear characteristics.
